(19) United States
(12) Patent Application Publication
(10) Pub. No.: US 2008/0311414 A1
(43) Pub. Date: Dec. 18, 2008

(54) METHOD OF FORMING THIN METAL FILM AND THIN METAL FILM MANUFACTURED BY THE FORMING METHOD

(75) Inventors: Hisahiro TANAKA, Fukuoka (JP); Yasuhiro NOTOHARA, Fukuoka (JP); Ryuichi YATSUNAMI, Fukuoka (JP); Satoru MIYANISHI, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/138,561

(22) Filed: Jun. 13, 2008

(30) Foreign Application Priority Data
Jun. 15, 2007 (JP) P2007-158267

(51) Int. Cl. B32B 15/00; B05D 3/02

(52) U.S. Cl. 428/469; 427/372.2; 427/554; 427/383.3

(57) ABSTRACT

An under-layer 2 comprising a coupling agent having a metal element to be transformed to an oxide is disposed on the surface of an inorganic oxide substrate 1, and a liquid containing micro-fine metal particles dispersed therein is coated on the under-layer 2 to form a micro-fine metal particle layer 3. Then, temperature is elevated to a metallizing temperature of the micro-fine metal particles, to form a thin metal film layer 5.

### BACKGROUND

1. Field of the Invention

The present invention concerns a forming method of keeping goods adhesion between a thin metal film and a substrate, and a thin metal film prepared by the forming method.

2. Description of the Related Art

In recent years, micro-fine metal particles mixed and dispersed to an organic solvent and a resin into a paste have high fluidity like an ink and can form a thin metal film by a simple and convenient method of merely coating and baking on a substrate. A synthesis method of micro-fine metal particles is generally classified into three methods that are a solid phase method, a liquid phase method, and a gas phase method. Among them, since the solid phase method including pulverization has a limit in fine particulation, the liquid phase method and the gas phase method are suitable to the synthesis of micro-fine particles. An in-gas evaporation method as a typical gas phase method is a method of heat melting a metal and evaporating the same under vacuum being carrying on an inert gas, followed by coagulation. The liquid phase method is a method of adding a precipitating agent and water to a solution containing a metal salt thereby taking place a chemical reaction and forming fine particles by nuclear formation and growing of the resultant material, in which the resultant micro-fine metal particles are converted into a stable colloidal system without growing. For preparing a paste from the ultra-fine particles, it is important how to disperse the resultant micro-fine particles independently without coagulation, and a dispersion method of forming an organic molecular layer on the surface of the ultra-fine particles is mainly used. Particularly, since metal particles of several nm to several tens nm have a large surface area, they are highly active and are melted at a temperature lower than the inherent melting point of the metal.

Then, it has been attempted to manufacture a circuit substrate of forming a pattern on a substrate by using a paste containing the ultra-fine particles dispersed therein. However, since the thin metal film using ultra-fine particles of noble metals such as Ag, or Au less reacts with a smooth substrate and no sufficient adhesion cannot be obtained, there are disclosed, for example, of coating a paste containing ultra-fine metal particles dispersed therein on a glass substrate and then conducting baking at a temperature of 250° C. or higher and 300° C. or lower, thereby forming a thin metal film on the glass substrate, in which a silane coupling agent is used (for example, refer to JP-A-2004-175646 and JP-A-2004-179125).

However, even if the silane coupling agent is used, when baking is conducted at a temperature of 250° C. or higher and 300° C. or lower, the coupling agent is decomposed into silicon oxide and while this has close adhesion with a smooth substrate, sufficient adhesion cannot be obtained for a thin metal film using fine particles of a noble metal such as Ag or Au with the silicon oxide to result in a problem that metal wirings are peeled from a substrate, particularly, in a case of forming a metal plating film on thin metal wirings for increasing the conductivity, by a plating pretreatment or chemical treatment with a plating solution. Further, while there has been a method of forming unevenness on the surface of a smooth substrate by using chemicals or physical means and ensuring adhesion by an anchoring effect, this also resulted in a problem that no sufficient highly fine pattern can be obtained due to the presence of the physical unevenness on the surface of the substrate.

### SUMMARY

The present invention has been achieved in view of the above and it intends to provide a method of forming a metal film in which the metal film using fine metal particles on a smooth substrate is less peeled from the substrate, as well as a metal film prepared by the forming method. Further, the invention intends to provide a method of forming a metal film having good adhesion in which metal wirings are not peeled from a substrate even by a plating pretreatment or a chemical treatment with a plating solution upon forming a thin metal plating film on the metal wirings formed on the substrate for increasing the conductivity, as well as a metal film prepared by the forming method.

For solving the subject described above according to the invention, a coupling agent containing a metal element to be transformed to an oxide and a fine metal particle layer formed by applying a liquid containing fine metal particles dispersed therein are formed successively on the surface of a substrate and then temperature is elevated to a temperature where fine metal particles are metallized thereby forming a metal film layer.

The present invention can provide a method of forming a metal film capable of forming a metal film layer having good adhesion in which the metal film layer is not peeled from a substrate even by a plating pretreatment or chemical treatment with a plating solution upon forming a metal plating film on a metal film layer for increasing the conductivity.

### BRIEF DESCRIPTION OF THE DRAWINGS

FIG. 1 is a view showing an example of procedures for the method of forming a thin metal film according to Embodiment 1 of the invention.

FIG. 2 is a view showing an example of procedures for the method of forming a thin metal film according to Embodiment 1 of the invention.

FIG. 3 is a view showing an example of procedures for the method of forming a thin metal film according to Embodiment 1 of the invention.

FIG. 4 is a view showing an example of procedures for the method of forming a thin metal film according to Embodiment 1 of the invention.

FIG. 5 is a view showing an example of procedures for the method of forming a thin metal film according to Embodiment 1 of the invention.

FIG. 6 is a view showing an example of procedures for the method of forming a thin metal film according to Embodiment 1 of the invention.

FIG. 7 is a view showing an example of procedures for the method of forming a thin metal film according to Embodiment 2 of the invention.

FIG. 8 is a view showing an example of procedures for the method of forming a thin metal film according to Embodiment 2 of the invention.

FIG. 9 is a view showing an example of procedures for the method of forming a thin metal film according to Embodiment 2 of the invention.

FIG. 10 is a view showing an example of procedures for the method of forming a thin metal film according to Embodiment 2 of the invention.

FIG. 11 is a view showing an example of procedures for the method of forming a thin metal film according to Embodiment 2 of the invention.

FIG. 12 is a view showing an example of procedures for the method of forming a thin metal film according to Embodiment 2 of the invention.

### DETAILED DESCRIPTION

Preferred embodiments of this invention will be described below.

### Embodiment 1

FIG. 1 to FIG. 6 are views showing an example of a procedure for the method of forming a thin metal film according to Embodiment 1 of the invention. At first, as shown in FIG. 1, an inorganic oxide substrate 1 is provided. The material used for the inorganic oxide substrate 1 includes, for example, quartz glass, non-alkali glass, borosilicate glass, sapphire glass, alumina, and zirconia.

Then, as shown in FIG. 2, an under-layer 2 is formed over the entire surface of the inorganic oxide substrate 1 for improving an adhesion strength of a thin metal film layer 5 to be formed in the subsequent step to the inorganic oxide substrates 1.

The material for the under-layer 2 includes metals and metal oxides having affinity both with the thin metal film layer 5 comprising noble metal such as silver or gold and the inorganic oxide substrate 1 such as of glass. In this case, the metal can improve the adhesion with the thin metal film layer 5 by forming a diffusion layer with the thin metal film layer 5 by diffusion or the like. Further, in a case of using, for example, a glass substrate for the inorganic oxide substrate 1, since the surface of the glass substrate is constituted with silicon oxide and hydroxyl groups, the metal oxide reacts with the hydroxyl groups to improve the adhesion with the glass substrate. As described above, by way of the under-layer 2, adhesion between the inorganic oxide substrate 1 such as the glass substrate and the thin metal film layer 5 can be kept favorably. The metal for the under-layer includes, for example, titanium, zirconium, and aluminum. For uniformly applying the underlying layer metal on the surface of the inorganic oxide substrate 1 a compound having a structure of a coupling agent can be used suitably and, for example, a titanate type coupling agent, zirconium type coupling agent, and aluminum type coupling agent can be used.

The under-layer 2 is formed by dissolving the materials described above into an appropriate solvent, for example, methanol, ethanol, or toluene to prepare a coating solution and coating the coating solution on the surface of the inorganic oxide substrate 1 by using a coating method such as spin coating, dip coating, or bar coating.

The under-layer 2 is decomposed and oxidized at a temperature of metallizing ultra-fine metal particles of about 200° C. to 400° C. to partially form a metal oxide. For forming the under-layer 2, the metal oxide may be formed partially by a heat treatment of metallizing micro-fine metal particles to be described later, or the under-layer 2 may be previously transformed partially into a metal oxide by various heating devices before metallizing the micro-fine metal particles.

Further, the titanate type coupling agent, the zirconium-type coupling agent, and the aluminum-type coupling agent may be used in admixture.

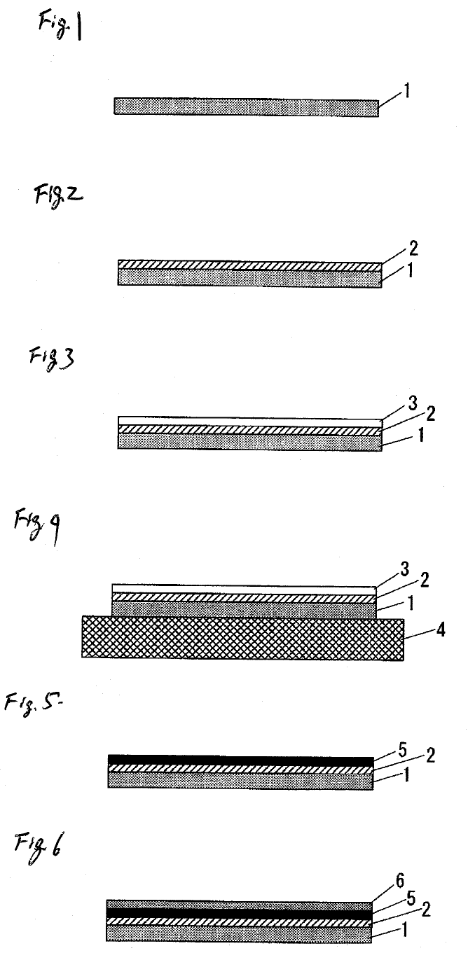

Then, as shown in FIG. 3, a liquid containing micro-fine metal particles dispersed therein is coated on the inorganic oxide substrate 1 on which the under-layer 2 has been formed by utilizing a coating method such as spin coating, dip coating, or bar coating, to form a micro-fine metal particle layer 3.

Then, as shown in FIG. 4, after air drying the micro-fine metal particle layer 3, a heat at which the micro-fine metal particles reach a metallizing temperature is applied to the micro-fine metal particle layer 3 by using a heating device 4 such as a laser annealing device, thermal head, heating furnace, or hot plate. As a result, as shown in FIG. 5, the micro-fine metal particle layer 3 is metallized to form a thin metal film layer 5. This provides an effect of transforming a portion of the under-layer 2 into a metal oxide under heating by the heating device 4 and capable of uniformly heating the coupling agent on the inorganic oxide substrate simultaneously with metallization of the micro-fine metal particle layer 3.

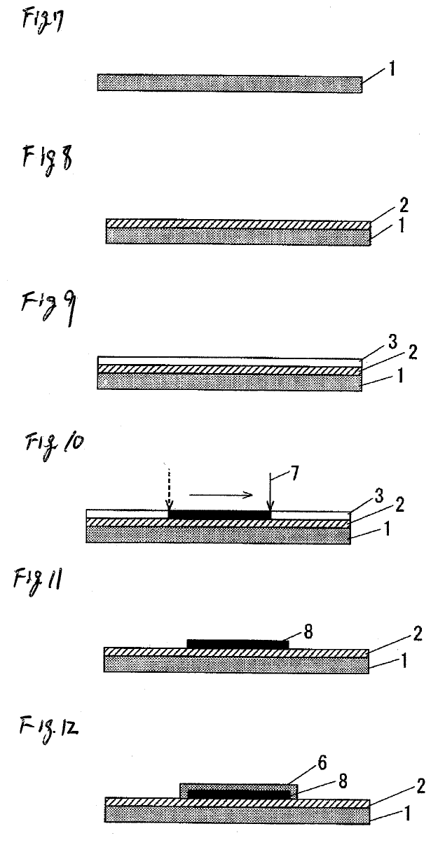

Then, for increasing the conductivity of the thin metal film layer 5 obtained in FIG. 6, the thickness of the thin metal film layer 5 is increased by a plating treatment as shown in FIG. 7. Specifically, after surface conditioning the thin metal film layer 5 with a pretreatment of alkali degreasing and acid activation, a plating treatment is applied on the thin metal film layer 5 to form a plating layer 6. As the kind of the metal to be plated, metals such as copper, gold, silver, palladium and nickel can be used in accordance with the application use. Further, as the method of the plating treatment, either electrolytic or electro-less type may be conducted properly. With the treatment described above, a thin metal film (thin metal film layer 5+plating layer 6) of good adhesion is formed on the smooth inorganic oxide substrate 1.

This Embodiment 1 has an effect capable of forming the thin metal film layer 5 of good adhesion on the smooth inorganic oxide substrate 1. Further, it has an effect capable of forming the plating layer 6 on the thin metal film layer 5 and increasing the conductivity of the thin metal film layer 5 without peeling the thin metal film layer 5 from the inorganic oxide substrate 1 even by applying the plating treatment or the chemical treatment with the plating solution after forming the thin metal film layer 5.

That is, since adhesion between the inorganic oxide substrate 1 and the thin metal film layer 5 is improved by the under-layer 2, peeling of the thin metal film layer 5 from the inorganic oxide substrate 1 can be prevented even when plating is applied over the thin metal film layer 5.

Further, the ultra-fine metal particles comprise an elemental metal and have an effect capable of improving the adhesion with the inorganic oxide substrate also for wirings using the elemental metal.

Further, the elemental metal comprises silver or gold and has an effect capable of improving adhesion with the inorganic oxide substrate also for wirings using an elemental metal of low resistivity.

### Embodiment 2

FIG. 7 to FIG. 12 are views showing an example of procedures for the method of forming a thin metal film according to Embodiment 2 of the invention. At first, in the same manner as the treatment shown in FIG. 1 to FIG. 3 for Embodiment 1, a coupling agent is coated over the entire surface on the inorganic oxide substrate 1 to form an under-layer 2, a ultra-fine metal particle layer 3 is formed over the entire surface on the under-layer 2, and then they are air dried (FIG. 7 to FIG. 9).

Then, as shown in FIG. 10, a laser light as heating means 7 is irradiated on the micro-fine metal particles layer 3 so as to form a predetermined pattern. Since this applies heat to a portion of the micro-fine particle layer 3 irradiated with the laser light, the micro-fine metal particle layer 3 at that portion is transformed into a thin metal film layer 5, whereas the micro-fine metal particle layer 3 at a position not irradiated by the laser light is not metallized but remains as it is. Further, this provides an effect capable of partially transformed the under-layer 2 at the position irradiated by the laser light to an oxide by heating and uniformly heating the coupling agent on the inorganic oxide substrate simultaneously with metallization of the ultra-fine metal particle layer 3.

Then, as shown in FIG. 11, the micro-fine metal particle layer 3 remained with no metallization is removed. Upon removal, it is removed, for example, with toluene. Thus, a thin metal film pattern 8 having a predetermined patterned shape is formed on the under-layer 2.

Then, as shown in FIG. 12, a plating layer 6 is formed by a plating treatment on the surface of the thin metal film pattern 8 for improving the conductivity of the thin metal film pattern 8 like the treatment shown in FIG. 6 for Embodiment 1. Also by the treatment described above, a thin metal film with good adhesion (thin metal film pattern 8+plating layer 6) is formed on the smooth inorganic oxide substrate 1.

According to Embodiment 2, since the laser light is irradiated only at the position intended to form the thin metal film pattern 8 of the micro-fine metal particle layer 3, the metallizing treatment for the micro-fine metal particle layer 3 and the wiring pattern forming treatment for the thin metal film layer 5 can be conducted simultaneously to provide an effect capable of shortening the treating step for forming the thin metal film pattern 8 in addition to the effect of Embodiment 1.

### EXAMPLE

Examples of the present invention are to be described below.

### Example 1

A thin metal film was formed by the method shown in FIG. 1 to FIG. 6 for Embodiment 1 described above. A 2-butanol solution of tetra-n-butyl titanate (ORGATIX TA-25 (trade name of products) manufactured by Matsumoto Chemical Industry Co., Ltd.) was prepared and an under-layer 2 was formed on a previously cleaned glass substrate as an inorganic oxide substrate 1 by a dipping method (pull-up speed: 25 mm/min) and air-dried. A fine particle silver ink dispersed in toluene (Ag1T (trade name of products), manufactured by ULVAC Materials, Inc.) was coated by a spin coating method and air dried to form a micro-fine metal particle layer 3 on the glass substrate. Then, for metallizing the micro-fine metal particles, it was heated by a hot plate as the heating device 4 at 300° C. for 2 min to obtain a thin silver film as a thin metal film layer 5 of 0.1 μm.

After cleaning the obtained thin silver film by a pretreatment step of alkali degreasing and acid activation, a copper plating film was formed as a plating layer 6 on the thin silver film. Plating was conducted by using a soluble anode of a copper ingot contained in an anode bag, at a room temperature and at a current density of 2 A/dm² for 136 sec by stirring with a stirrer to obtain a copper plating film of 1 μm.

Acecleans (trade name of products, manufactured by Okuno Chemical Industries Co.; 60 g/L) was used for alkali degreasing, an aqueous solution of 5 wt % sulfuric acid was used for acid activation, and 70 g/L of copper sulfate, 200 g/L of sulfuric acid, 50 mg/L chlorine ions, and 4 mL/L of an additive (Toprutina MKN-M (trade name of products) manufactured by Okuno Chemical Industry Co.) were used for a copper plating bath. For the thin metal film obtained by the treatment described above, a cross-cut tape peeling test was conducted.

### Example 2

A thin metal film was formed and the test was conducted by the same method as in Example 1 except for using titanium acetyl acetonate (ORGATIX TC-401 (trade name of products) manufactured by Matsumoto Chemical Industry Co.) as the coupling agent.

### Example 3

A thin metal film was formed and the test was conducted by the same method as in Example 1 except for using titanium bis(ethylhexoxo)bis(2-ethyl-3-hydroxyhexoxide) (ORGATIX TC-200 (trade name of products) manufactured by Matsumoto Chemical Industry Co.) as the coupling agent.

### Example 4

A thin metal film was formed and the test was conducted by the same method as in Example 1 except for using diisopropoxy titanium bis(triethanolaminate) (ORGATIX TC-400 (trade name of products) manufactured by Matsumoto Chemical Industry Co.) as the coupling agent.

### Example 5

A thin metal film was formed and the test was conducted by the same method as in Example 1 except for using tetra-n-butoxy zirconium (ORGATIX ZA-65 (trade name of products) manufactured by Matsumoto Chemical Industry Co.) as the coupling agent.

### Example 6

A thin metal film was formed and the test was conducted by the same method as in Example 1 except for using an aluminum compound (ORGATIX AL-80 (trade name of products) manufactured by Matsumoto Chemical Industry Co.) as the coupling agent, and a 1:1 solution of 2-propanol and toluene as a dilution solvent.

### Example 7

A thin metal film was formed and the test was conducted by the same method as in Example 1 except for using a fine gold particle ink formed by dispersing a fine particle ink in toluene (Au1T (trade name or products) manufactured by ULVAC Materials Inc.) and changing the heating temperature to 400° C.

### Example 8

A thin metal film was formed by the method shown in FIG. 7 to FIG. 12 for Embodiment 2 described above. A 2-butanol solution (Titanium coupling agent at 1 wt % concentration) of tetra-n-butyl titanate (ORGATIX TA-25 (trade name of products) manufactured by Matsumoto Chemical Industry Co., Ltd.) was prepared and an under-layer 2 was formed on a previously cleaned glass substrate as an inorganic oxide substrate 1 by a dipping method (pull-up speed: 25 mm/min) and air dried. A fine particle silver ink dispersed in toluene (Ag1T (trade name of products), manufactured by ULVAC Materials, Inc.) was coated by a spin coating method and air dried to form a micro-fine metal particle layer 3 on the glass substrate. Then, for metallizing the micro-fine metal particles, a laser light was irradiated at a power of 400 mW and at a scanning rate of 2 mm/sec by using a semiconductor laser at a wavelength of 670 nm (beam size: 10 μm×65 μm) as the heating device 7, and a portion not irradiated by the laser light was cleaned and removed by toluene to obtain a pattern of 0.1 μm thin silver film as a thin metal film pattern.

After cleaning the obtained thin silver film pattern by a pretreatment step of alkali degreasing and acid activation, a copper plating film was formed as a plating layer 6 on the thin silver film pattern. Plating was conducted by using a soluble anode of a copper ingot contained in an anode bag at a room temperature and at a current density of 2 A/dm² for 136 sec by stirring with a stirrer to obtain a copper plating film of 1 μm.

Acecleans (trade name of products, manufactured by Okuno Chemical Industries Co., 60 g/L) was used for alkali degreasing, an aqueous solution of 5 wt % sulfuric acid was used for acid activation, and 70 g/L of copper sulfate, 200 g/L of sulfuric acid, 50 mg/L of chlorine ions and 4 mL/L of additive (Toprutina MKN-M (trade name of products) manufactured by Okuno Chemical Industries Co.) were used for a copper plating bath. By the treatment described above, a good copper plating film was formed with no peeling of the thin silver film pattern also during copper plating. Then, a cross-cut tape peeling test was conducted for the obtained thin metal film.

### Example 9

A thin metal film was formed and the test was conducted by the same method as in Example 8 except for using titanium acetyl acetonate (ORGATIX TC-401 (trade name of products) manufactured by Matsumoto Chemical Industry Co.) as the coupling agent.

### Example 10

A thin metal film was formed and the test was conducted by the same method as in Example 8 except for using titanium bis(ethylhexoxo)bis(2-ethyl-3-hydroxyhexoxide) (ORGATIX TC-200 (trade name of products) manufactured by Matsumoto Chemical Industry Co.) as the coupling agent.

### Example 11

A thin metal film was formed and the test was conducted by the same method as in Example 8 except for using diisopropoxy titanium bis(triethanolaminate) (ORGATIX TC-400 (trade name of products) manufactured by Matsumoto Chemical Industry Co.) as the coupling agent.

### Example 12

A thin metal film was formed and the test was conducted by the same method as in Example 8 except for using tetra-n-butoxy zirconium (ORGATIX ZA-65 (trade name of products) manufactured by Matsumoto Chemical Industry Co.) as the coupling agent.

### Example 13

A thin metal film was formed and the test was conducted by the same method as in Example 8 except for using an aluminum compound (ORGATIX AL-80 (trade name of products) manufactured by Matsumoto Chemical Industry Co.) as the coupling agent and a 1:1 solution of 2-propanol and toluene as a dilution solvent.

### Example 14

A thin metal film was formed and the test was conducted by the same method as in Example 8 except for using a fine gold particle ink formed by dispersing a fine particle ink in toluene (Au1T (trade name or products) manufactured by ULVAC Materials Inc.) and changing the scanning rate of the laser light to 4 mm/sec.

### Comparative Example 1

A thin metal film was prepared and the performance was compared in the same method as in Example 1 except for not applying the coating treatment of the coupling agent on the glass substrate.

### Comparative Example 2

A thin metal film was formed and the performance was compared in the same method as in Example 1 except for using hexyl trimethoxy silane (TSL8241 (trade name of products), manufactured by GE Toshiba Silicon Co., Ltd.) as the coupling agent.

### Comparative Example 3

A thin metal film was formed and the performance was compared in the same method as in Example 1 except for using 3-aminopropyltriethoxy silane (TSL8331 (trade name of products), manufactured by GE Toshiba Silicon Co., Ltd.) as the coupling agent.

### Comparative Example 4

A thin metal film was formed and the performance was compared by the same method as in Example 8 except for not applying the coating treatment of the coupling agent on the glass substrate.

### Comparative Example 5

A thin metal film was formed and the performance was compared in the same method as in Example 8 except for using hexyl trimethoxy silane (TSL8241 (trade name of products), manufactured by GE Toshiba Silicon Co., Ltd.) as the coupling agent.

### Comparative Example 6

A thin metal film was formed and the performance was compared in the same method as in Example 8 except for using 3-aminopropyltriethoxy silane (TSL8331 (trade name of products), manufactured by GE Toshiba Silicon Co., Ltd.) as the coupling agent.

(Table 1) shows the result of evaluation for the adhesion by a cross-cut tape peeling test in (Examples 1 to 14) and (Comparative Examples 1 to 6) described above.

TABLE 1

| | Type of | Type of fine metal | |
|---|---|---|---|
| | pretreatment agent | particles | Evaluation |
| Example 1 | Ti type | Ag | ⊚ |
| Example 2 | Ti type | Ag | ⊚ |
| Example 3 | Ti type | Ag | ⊚ |
| Example 4 | Ti type | Ag | ⊚ |
| Example 5 | Zr type | Ag | ◯ |
| Example 6 | Al type | Ag | ◯ |
| Example 7 | Ti type | Au | ⊚ |
| Example 8 | Ti type | Ag | ⊚ |
| Example 9 | Ti type | Ag | ⊚ |
| Example 10 | Ti type | Ag | ⊚ |
| Example 11 | Ti type | Ag | ⊚ |
| Example 12 | Zr type | Ag | ◯ |
| Example 13 | Al type | Ag | ◯ |
| Example 14 | Ti type | Au | ⊚ |
| Comp. Example 1 | — | Ag | X |
| Comp. Example 2 | Si type | Ag | Δ |
| Comp. Example 3 | Si type | Ag | Δ |
| Comp. Example 4 | — | Au | X |
| Comp. Example 5 | Si type | Au | Δ |
| Comp. Example 6 | Si type | Au | Δ |

As shown in (Comparative Examples 1 to 6), in a case of not coating the coupling agent as the pretreatment agent or in a case of using Si type coupling agent, adhesion between the thin metal film and the inorganic oxide substrate 1 by way of the coupling agent is not good.

On the other hand, as shown in (Examples 1 to 14) according to the invention, by using the coupling agent comprising a metal having good adhesion both with the thin metal film and the inorganic oxide substrate 1, when the plating pretreatment or the chemical treatment by the plating solution is conducted upon forming the metal plating film on the thin metal film layer 5 or the thin metal film pattern 8 for improving the conductivity, it is not peeled from the inorganic oxide substrate 1 of a planar surface and a thin metal film having good adhesion can be formed.

Further, when compared with a product, for example, as described in SEI technical Review, No. 168, pages 91-92 in March, 2006, in which adhesion is intended to be improved between the glass substrate and the thin metal film comprising an Ag alloy using the Ag alloy comprising Ag mixed with a different metal by baking at 300° C. for a long time of 30 min, treatment can be conducted in a short time of 2 min at 300° C. after forming the under-layer 2 of the coupling agent of the metal to the inorganic oxide substrate 1 and after coating the fine silver particle on the inorganic oxide substrate 1 as described above.

As described above, by forming a material having a metal element to be transformed to an oxide containing an element such as titanium, zirconium, and aluminum as the coupling agent and having good adhesion both with the inorganic oxide substrate and the thin metal film as the under-layer to the inorganic oxide substrate and utilizing the same as the intermediate layer between the inorganic oxide substrate and the thin metal film, the thin metal film is less peeled from the inorganic oxide substrate and a thin metal film having good adhesion can be formed.

This application is based upon and claims the benefit of priority of Japanese Patent Application No 2007-158267 filed on 2007 Jun. 15, the content of which are incorporated herein by reference in its entirety.

What is claimed is:

1. A method of forming a metal film, comprising:
providing a coupling agent having a metal element to be transformed to an oxide on a substrate;
coating a liquid in which fine metal particles are dispersed on the coupling agent so as to form a fine metal particle layer; and
elevating a temperature to a temperature where the fine metal particles are metallized so as to form a metal film layer.

2. The method of forming a metal film according to claim 1, wherein the step of elevating the temperature is a step of heating an entire part of the inorganic oxide substrate by a heating furnace.

3. The method of forming a metal film according to claim 1, wherein the step of elevating the temperature is a step of irradiating a laser light so as to apply heat locally to the fine metal particles.

4. The method of forming a metal film according to claim 3, wherein the laser light is irradiated in a predetermined pattern over the fine metal particle layer.

5. The method of forming a metal film according to claim 1, wherein the substrate is an inorganic oxide substrate; and
the metal element to be transformed to the oxide includes at least one element of titanium, zirconium, and aluminum.

6. The method of forming a metal film according to claim 1, wherein the fine metal particles are comprised of an elemental metal.

7. The method of forming a metal film according to claim 6, wherein the elemental metal is silver or gold.

8. The method of forming a metal film according to claim 1, further comprising:
forming a metal plating film on the surface of the metal film layer.

9. The method of forming a metal film according to claim 8, wherein the metal plating film comprises copper.

10. A metal film substrate formed by coating fine metal particles on the surface of a substrate and elevating the temperature to a metallizing temperature so as to form a metal film layer,
wherein a metal oxide is disposed between the substrate and the metal film layer.
